(19) United States
(12) Patent Application Publication
(10) Pub. No.: US 2013/0025988 A1
(43) Pub. Date: Jan. 31, 2013

(54) SEALING DEVICE FOR HYDRAULIC BRAKE LEVER ASSEMBLY

(71) Applicant: Wayne-Ian Moore, Changhua County (TW)

(72) Inventor: Wayne-Ian Moore, Changhua County (TW)

(21) Appl. No.: 13/647,367

(22) Filed: Oct. 8, 2012

Related U.S. Application Data
(63) Continuation-in-part of application No. 12/861,836, filed on Aug. 24, 2010.

(51) Int. Cl. B60T 11/10; F16J 15/16

(52) U.S. Cl. 188/344

(57) ABSTRACT

A sealing device for hydraulic brake lever assembly includes a seat having an oil tank defined therein for receiving oil. The oil tank has a connecting hole defined therein. The oil tank is conically tapered toward the bottom thereof. An elastomer is sealingly received in the oil tank. The elastomer has an U-shaped portion formed therein for providing a resilient force. The elastomer has a movable portion formed therein. A piston assembly is received in the oil tank and connected to the elastomer for actuating the elastomer. At least one oil seal is sleeved on the driving shank for preventing oil leakage. When braking, the piston assembly actuates the U-shaped portion to deform. The movable portion is pushed to pressing oil into the connecting hole. When an oil pressure is decreased, the U-shaped portion restores. The movable portion is pulled backward by the resilient force.

### CROSS-REFERENCE TO RELATED APPLICATION

This application is a Continuation-In-Part Application of U.S. application Ser. No. 12/861,836, filed 24 Aug. 2010, and entitled “SEALING DEVICE FOR HYDRAULIC BRAKE LEVER ASSEMBLY”, now pending.

### BACKGROUND OF THE INVENTION

1. Field of the Invention

The present invention relates to a sealing device and more particularly to a sealing device for hydraulic brake lever assembly sealingly disposed in an oil tank for preventing oil leakage and effectively pressing hydraulic oil from an oil tank into a hydraulic tube.

2. Description of Related Art

A conventional brake system for a bicycle is important to control a bicycle speed and ensure the riding safety. As for a conventional hydraulic disc brake system, the system comprises a tank receiving hydraulic oil. One end of the tank is connected to a brake lever which is able to be pressed. The other end of the tank is connected to a hydraulic tube which is connected to a disc brake caliper. When a rider presses the brake lever, the hydraulic oil would be pushed from the tank to the hydraulic tube, and actuate the brake linings of the disc brake caliper to abut against a wheel rim for braking. The oil pressure would not be suddenly decreased due to the high viscosity of the hydraulic oil in the hydraulic disc brake system. The brake linings of the disc brake caliper can avoid wearing quickly. When braking, the bicycle would keep its balance and have a better braking effect. Therefore, the hydraulic disc brake system is commonly applied on bicycles, particularly to the off-road bicycles or mountain bicycles.

Furthermore, the conventional hydraulic disc brake system has a piston device slildably received in the tank. A storage chamber is located adjacent to the tank. The tank has a first bore and a second bore defined therein for communicating with the storage chamber. The hydraulic oil is able to flow between the storage chamber and the tank via the first and second bores. When the rider presses the brake lever, the hydraulic oil would be pushed by the piston device from the tank to the hydraulic tube, and actuate the brake linings of the disc brake caliper to abut against a wheel rim for braking, such that the bicycle speed is controlled or the bicycle can be stopped.

However, when riding on a rough road, the rider needs to brake the bicycle intermittently. As the piston device pushes the hydraulic oil to the hydraulic tube, an oil seal element which is disposed inside the tank slides back and forth with the piston device along the tank. The oil seal element would be easily worn due to the friction of the tank. Moreover, the temperature in the tank accelerates the aging of the oil seal element so as to cause the oil leak. The braking effect is also reduced, and the safety in riding is seriously affected.

The present invention has arisen to mitigate and/or obviate the disadvantages of the conventional hydraulic disc brake system.

### SUMMARY OF THE INVENTION

The main objective of the present invention is to provide an improved sealing device for hydraulic brake lever assembly which provides for preventing oil leakage and effectively pressing hydraulic oil into a hydraulic tube.

To achieve the objective, a sealing device for hydraulic brake lever assembly which has a brake lever comprises a seat pivotally connected to the brake lever. The seat has an oil tank defined therein for receiving hydraulic oil. The oil tank is conically tapered toward a bottom thereof. The oil tank has a connecting hole defined in the bottom thereof and extending therethrough to adapt to connect with a hydraulic tube which is connected to a hydraulic disc brake caliper.

An elastomer is movably and sealingly received in the oil tank. An outer periphery of the elastomer tightly abuts against an inner periphery of the oil tank for providing a friction force. The elastomer has a through hole axially defined therein. The elastomer has an U-shaped portion annularly and integrally formed therein for providing a resilient force. A movable portion is formed in a center of the elastomer and connected to the U-shaped portion. The elastomer has an annular flange formed in one end thereof and located opposite to the U-shaped portion.

A piston assembly is movably and axially received in the oil tank. The piston assembly comprises a driving shank having a driving head formed in one end thereof. The driving head has an annular protrusion formed in an outer periphery thereof. The driving head of the driving shank passes through the through hole of the elastomer and the annular protrusion is received in the through hole for abutting against the annular flange of the elastomer. A press rod is coaxially connected to the driving shank. One end of the press rod is connected to one end of the driving shank opposite to the driving head. An opposite end of the press rod is pivotally connected to the brake lever. At least one oil seal is sleeved on the driving shank and abuts against the inner periphery of the oil tank to prevent oil leakage.

When the brake lever is pressed to pivotally actuate the piston assembly, the press rod and the driving shank are actuated by the brake lever to axially move toward the seat. The driving head of the driving shank axially moves toward the bottom of the oil tank. The outer periphery of the elastomer abuts against the inner periphery of the oil tank for remaining in place. The U-shaped portion of the elastomer deforms and the movable portion is simultaneously pushed to move toward the bottom of the oil tank by the driving head for pressing hydraulic oil into the connecting hole. When an oil pressure in the oil tank is decreased, the U-shaped portion restores. The movable portion and the driving head are pulled backward by the resilient force of the U-shaped portion.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a sealing device for hydraulic brake lever assembly in accordance with the present invention;

FIG. 2 is an assembled perspective view of the sealing device for hydraulic brake lever assembly in accordance with the present invention;

FIG. 3 is a plane view of the sealing device for hydraulic brake lever assembly in accordance with the present invention; and

FIGS. 4-5 are operational and cross-sectional plane view of the sealing device for hydraulic brake lever assembly in accordance with the present invention.

### DETAILED DESCRIPTION OF THE INVENTION

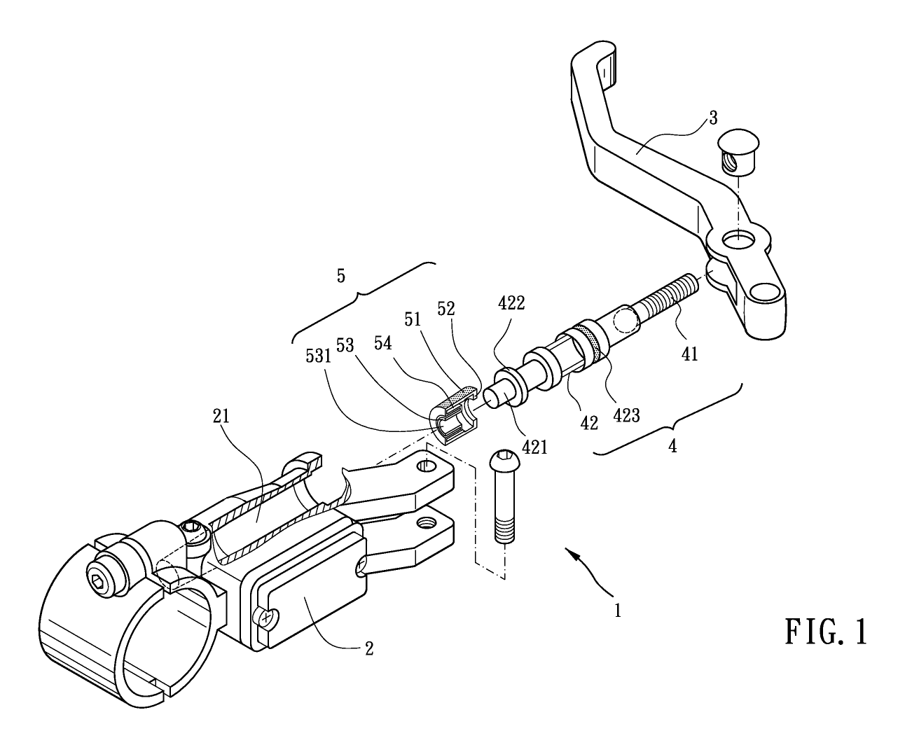

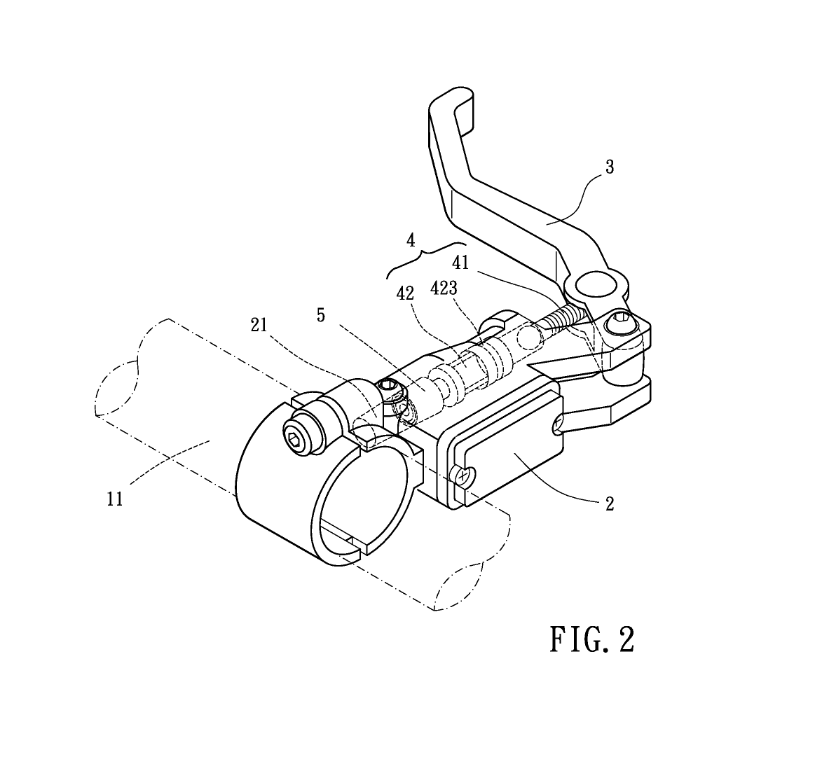

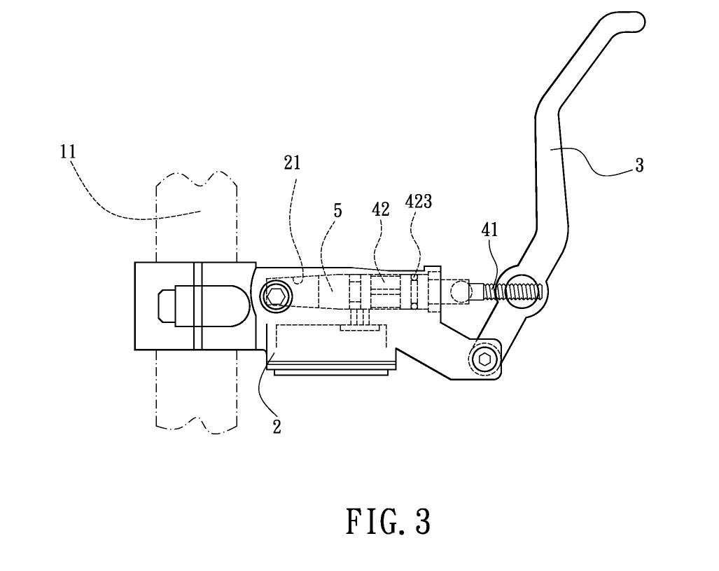

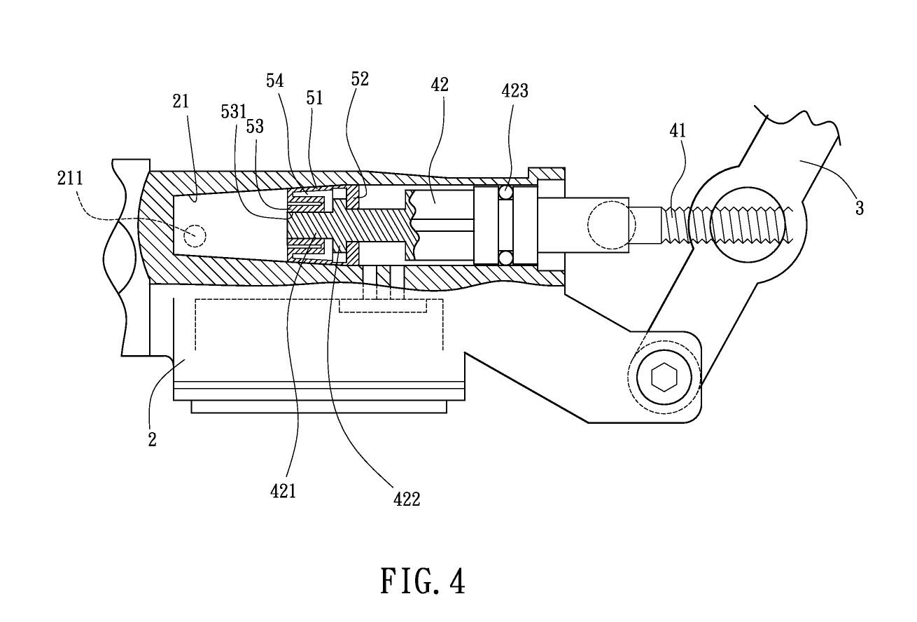

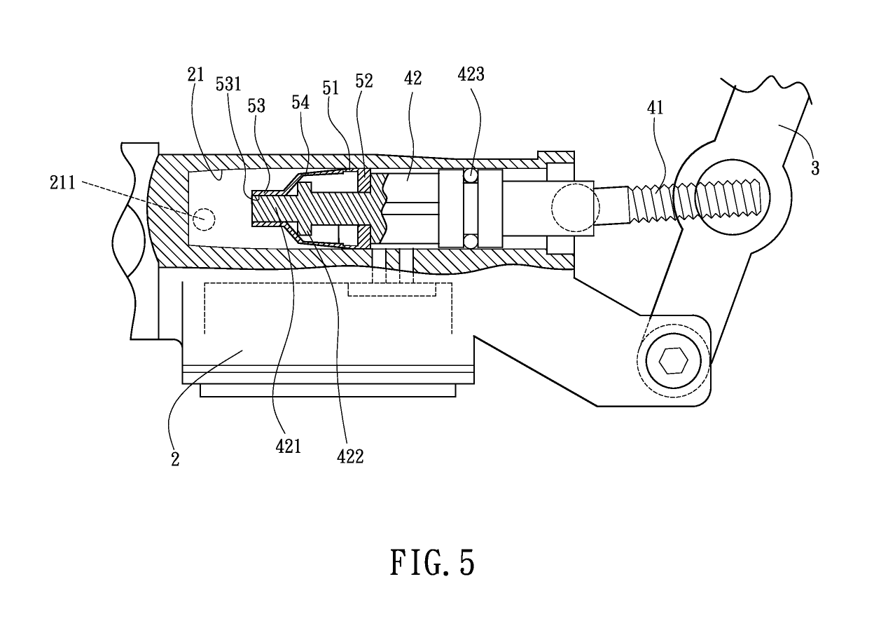

Referring to the drawings to FIGS. 1-5, a sealing device 1 for hydraulic brake lever assembly which has a brake lever 3 in accordance with the present invention comprises a seat 2. One end of the seat 2 is connected to a bicycle handlebar 11 (shown in FIGS. 2-3) and another end of the seat 2 is pivotally connected to the brake lever 3. The seat 2 has an oil tank 21 defined therein for receiving hydraulic oil. A bottom of the oil tank 21 is located close to the bicycle handlebar 11. The oil tank 21 is conically tapered toward the bottom thereof. The oil tank 21 is symmetrical with respect to a center thereof. The oil tank 21 has a connecting hole 211 (shown in FIGS. 4-5) defined in the bottom thereof and extending therethrough to connect with a hydraulic tube (not shown) which is connected to a hydraulic disc brake caliper (not shown).

An elastomer 5 is movably and sealingly received in the oil tank 21. The elastomer 5 is in a cylindrical shape and made of rubber. An outer periphery 51 of the elastomer 5 tightly abuts against an inner periphery of the oil tank 21 for providing a friction force and preventing oil leakage. The elastomer 5 has a through hole 531 axially defined therein. The elastomer 5 has a reversed U-shaped portion 54 annularly and integrally formed at one end thereof for providing a resilient force. A movable portion 53 is formed in a center of the elastomer 5 and connected to the U-shaped portion 54. The elastomer 5 has an annular flange 52 formed at another end thereof and extending inwardly. The annular flange 52 is located opposite to the U-shaped portion 54.

A piston assembly 4 is movably and axially received in the oil tank 21. The piston assembly 4 comprises a driving shank 42 and a press rod 41. The driving shank 42 has a driving head 421 formed at one end thereof. The driving head 421 has an annular protrusion 422 formed at an outer periphery thereof. The driving head 421 of the driving shank 42 passes through the through hole 531 of the elastomer 5. The annular protrusion 422 of the driving shank 42 is received in the through hole 531 and abuts against the annular flange 52 of the elastomer 5 for engaging with each other. One end of the press rod 41 is coaxially connected to one end the driving shank 42 which is opposite to the driving head 421. Another end of the press rod 41 is pivotally connected to the brake lever 3. An oil seal 423 is sleeved on the driving shank 42 and is located between the driving head 421 and the press rod 41. The oil seal 423 abuts against the inner periphery of the oil tank 21 to prevent oil leakage.

Referring to FIGS. 4 and 5, the operation of the seal device 1 for hydraulic brake lever assembly is illustrated. FIG. 4 shows the seal device 1 for hydraulic brake lever assembly is in an initial condition. The elastomer 5 is received in the oil tank 21 of the seat 2 and sleeved on the driving head 421 of driving shank 42. The annular flange 52 of the elastomer 5 abuts against the annular protrusion 422 of the driving shank 42.

As shown in FIG. 5, when braking, the brake lever 3 is pressed to pivotally rotate toward the seat 2 and actuates the piston assembly 4. The press rod 41 is actuated by the brake lever 3 to axially move toward the seat 2. The driving shank 42 is axially pushed toward the bottom of the oil tank 21 by the press rod 41. The outer periphery 51 of the elastomer 5 abuts against the inner periphery of the oil tank 21 for remaining in place. The U-shaped portion 54 of the elastomer 5 deforms and the movable portion 53 is simultaneously pushed to move toward the bottom of the oil tank 21 by the driving head 421 for pressing hydraulic oil into the hydraulic disc brake caliper (not shown) via the connecting hole 211 and the hydraulic tube (not shown).

When an oil pressure in the oil tank 21 is decreased, the U-shaped portion 54 restores. The movable portion 53 and the driving head 421 are pulled backward by the resilient force of the U-shaped portion 54. And the sealing device 1 for hydraulic brake lever assembly returns to the initial condition.

Therefore, a braking effect is stabilized and a braking force is enhanced by the deformation of the U-shaped portion 54 of the elastomer 5. The sealing device 1 for hydraulic brake lever assembly in accordance with the present invention provides for preventing oil leakage and effectively pressing hydraulic oil from the oil tank 21 into a hydraulic tube (not numbered).

Referring to FIGS. 4-5, the oil tank 21 is conically tapered toward the bottom thereof. A cross-sectional area of the inner periphery of the oil tank 21 is decreased toward the bottom of the oil tank 21, such that a periphery of the annular flange 52 of the elastomer 5 will not move toward the bottom of the oil tank 21 because the annular flange 52 of the elastomer 5 will be fastened by a size difference between the annular flange 52 and the cross-sectional area of the inner periphery of the oil tank 21 even through the elastomer 5 is elastic. Therefore, the annular flange 52 of the elastomer 5 is fastened as the movable portion 53 of the elastomer 5 and the U-shaped portion 54 of the elastomer 5 is moved when the driving head 421 is moved forwardly and backwardly. In particular, in a braking process where the driving head 421 uniformly presses an amount of hydraulic oil from the oil tank into the hydraulic tube, since a cross-sectional area of the oil tank 21 in a later period of the braking process is smaller than another cross-sectional area of the oil tank 21 in an earlier period of the braking process, a momentary flow rate of hydraulic oil in the later period of the braking process is faster than another momentary flow rate of hydraulic oil in the earlier period when a constant force is applied to press the driving head 421. Therefore, a bicycle rider can control the brake lever assembly well during the braking process because of the conically tapered structure of the oil tank 21.

Although the invention has been explained in relation to its preferred embodiment, it is to be understood that many other possible modifications and variations can be made without departing from the spirit and scope of the invention as hereinafter claimed.

What is claimed is:

1. A sealing device for hydraulic brake lever assembly having a brake lever and comprising:
a seat pivotally connected to the brake lever, the seat having an oil tank defined therein for receiving hydraulic oil, the oil tank having a connecting hole defined in a bottom thereof and extending therethrough for connecting with a hydraulic tube, the oil tank being conically tapered toward the bottom thereof;
an elastomer movably and sealingly received in the oil tank, an outer periphery of the elastomer tightly abutting against an inner periphery of the oil tank, the elastomer having a through hole axially defined therein, the elastomer having an U-shaped portion annularly and integrally formed therein for providing a resilient force, the elastomer having a movable portion formed in a center thereof and connected to the U-shaped portion;
a piston assembly movably and axially received in the oil tank and comprising:
a driving shank having a driving head formed in one end thereof, the driving head passing through the through hole of the elastomer, the driving head having an annular protrusion formed in an outer periphery thereof for abutting against the elastomer;
a press rod coaxially connected to the driving shank, one end of the press rod connected to one end of the driving shank opposite to the driving head, an opposite end of the press rod pivotally connected to the brake lever, and
at least one oil seal sleeved on the driving shank and abutting against the inner periphery of the oil tank to prevent oil leakage ;
wherein when the brake lever is pressed to pivotally actuate the piston assembly, the driving head of the driving shank is driven by the brake lever to axially move toward the bottom of the oil tank, the outer periphery of the elastomer abutting against the inner periphery of the oil tank for remaining in place, the U-shaped portion of the elastomer deforming, the movable portion simultaneously pushed to move toward the bottom of the oil tank by the driving head for pressing hydraulic oil into the connecting hole; when an oil pressure in the oil tank is decreased, the U-shaped portion restores, the movable portion and the driving head pulled backward by the resilient force of the U-shaped portion.

2. The sealing device for hydraulic brake lever assembly as claimed in claim 1, wherein the elastomer has an annular flange formed in one end thereof and located opposite to the U-shaped portion for abutting against the annular protrusion of the driving shank.
